(19) United States
(12) Patent Application Publication
(10) Pub. No.: US 2009/0226832 A1
(43) Pub. Date: Sep. 10, 2009

(54) TONER OF STATIC CHARGE IMAGE AND METHOD FOR MANUFACTURING THE SAME

(75) Inventors: Shunquan ZHU, Wuhan (CN); Xiukui WANG, Wuhan (CN); Yubin WANG, Wuhan (CN)

Correspondence Address: MATTHIAS SCHOLL, 14781 MEMORIAL DRIVE, SUITE 1319, HOUSTON, TX, 77079, US

(73) Assignee: HUBEI DINGLONG CHEMICAL CO., LTD., Wuhan (CN)

(21) Appl. No.: 12/112,055

(22) Filed: Apr. 30, 2008

(30) Foreign Application Priority Data
Mar. 6, 2008 (CN) 200810047016.2

(51) Int. Cl. G03G 9/08

(52) U.S. Cl. 430/105; 430/137.15

(57) ABSTRACT

The invention is related to a toner of static charge image and a method for manufacturing such a toner of static charge image, which solve the problems of existing toner of static charge image, namely easy detachment of colorant, the pollution of carriers and developing sleeves and low durability. For the toner of static charge image obtained by aggregation of at least polymer particles, the polymer particles at least contain polymer particles A with inner wax and polymer particles B with inner colorant. The toner of static charge image of the invention exhibits good effect of fixing characteristics, not causing the pollution of carriers and developing sleeves, and could maintain long-term stable performance.

### CROSS-REFERENCE TO RELATED APPLICATIONS

This application claims priority to Chinese Patent Application No. 200810047016.2 filed on Mar., 6, 2008. The contents of which are incorporated herein by reference.

### BACKGROUND OF THE INVENTION

1. Field of the Invention

The invention is related to an electronic photo copier and the toner of static charge image used by copiers, especially a toner of static charge image with excellent property of fixation characteristics, viscous roll resistance and durability and a method for manufacturing the same.

2. Description of the Related Art

In the field of electronic photo, the toner of static charge image used so far is manufactured first by dissolution of adhesive resins such as styrene acrylic resin or polyester resin, coloring agents such as carbon black and pigment, and release agents such as wax, in which the solutes are refined together, and then smashed and classified. But there are control limits about particle size of the toner manufactured by the method of dissolution and refining/smash mentioned above. The manufacture of high yield below 10 μm, especially 8 μm, is very difficult, which can not meet the future requirements of high-resolution electronic photo.

In addition, the wax with low softening point is dispersed in the toner in the mixed refining, which is the general method of so-called oil-free development. But in the method of dissolution and refining/smash before, if more wax is contained, wax would be detached while smashing, and surplus wax still exists on the toner surface to cause the pollution of vectors and develop sleeves, or the curtailment of longevity. Moreover, filming is formed on the photoreceptor by wax, which could cause image defect. In addition, it is unable to give full play of “low temperature fixing property” because of wax detachment.

In a Japanese patent document with public notice 63-186253, a method for manufacturing the tone using emulsion polymerization/aggregation is described in order to conquer the control problem of particle size. But the method is the process of aggregating resin particles, wax particles and colorants. If it is expected to contain more wax, the detachment of wax particles will occur, causing the above-mentioned problems, such as the pollution of carriers and developing sleeves, as well as the filming formed on the photoreceptor by wax, which could not ensure the durability.

In a Japanese patent document with public notice 2001-27821, a method for manufacturing the tone by aggregating colorants and polymer particles is described, in which wax particles are used as the seeds of polymer particles. According to the method, more wax can be contained in the toner to some extent, thus it is a good way to improve fixation characteristics. However, the colorant is dispersive and low-use, and the image concentration can not be improved. In addition, the detachment of colorant is easy to occur so as to cause the pollution of carriers and developing sleeve, and the endurance is low.

### SUMMARY OF THE INVENTION

One of the objective of the invention is to overcome the disadvantages of toner of static charge image used before and to provide a toner of static charge image with excellent property of viscous roll resistance and durability.

Another objective of the invention is to provide a method for manufacturing the tone of static charge image mentioned above.

The inventor concentrates on the research of issue mentioned above, and finds that the toner particles, formed by the aggregation of polymer particles with inner wax and polymer particles with inner colorant, can solve the problems mentioned above. That is to say that, both wax and colorant are inside the polymer particle in the invention. The polymers are aggregated through the aggregation of polymer particles respectively containing wax and colorant, and fused to obtain toner particles through the aggregation of polymers. Thus, colorants can also be dispersed in the toner when it is smaller than polymer particle size. In addition, the wax, which is difficult to fuse, is also inside the polymer particle. Thus it would not be detached and can be contained in the toner while aggregation and fusion, and can be concluded to solve the issue mentioned above.

That is to say that the technical scheme is: for the toner of static charge image obtained through the aggregation of polymer particles, the polymer particles at least contains polymer particles A with inner wax and polymer particles B with inner colorant.

The invention is described in detail below. The polymer particle A with inner wax can be formed through the polymerization of wax as a seed. The seed wax of the invention could be any kind of well-known wax, and the specific examples are: olefin wax, such as low molecular weight polyethylene, low molecular weight polypropylene and copolymer polyethylene wax, or hydrocarbons wax, such as paraffin and microcrystalline wax, or a long-chain aliphatic-based ester wax, such as 22,22 acid ester, lignite acid ester 22,18,18 acid ester and pentaerythritol tetrabehenate, or natural wax, such as Brazil palm wax and beeswax, or senior fatty acid amide, such as oleic acid amide and stearic acid amide. In order to improve low temperature fixing properties, for these wax, the melting point of relatively good wax is below 100° C., and the preferred melting point is 40-90° C., the more preferred melting point is 60-85° C. If the melting point is over 100° C., the effect of low temperature fixing properties become bad.

In order to use the wax of the invention as a seed, the wax mentioned above can be dispersed and prepared in aqueous medium with the presence of at least a surfactant, which is selected among the known cationic surfactants, anionic surfactants and non-ionic surfactants. Two or more kinds of these surfactants can also be used together. The specific examples of cationic surfactants are dodecyl ammonium chloride, dodecyl ammonium bromide, dodecyltrimethyl ammonium bromide, dodecyl chloride pyridine, dodecyl ammonium pyridine and cetyltrimethyl ammonium bromide, etc.

In addition, the specific examples of anionic surfactants are sodium stearate, sodium dodecanoate, sodium dodecyl sulfate, sodium dodecyl benzene sulfonate, sodium dodecyl sulfate, and other metal salts of senior fatty acid, etc.

In addition, the specific examples of non-ionic surfactants are: poly(oxyethylene) dodecy ether, poly(oxyethylene)hexadecyl ether, poly(oxyethylene)nonyl-phenyl ether, poly(oxyethylene)lauryl ether, sorbitan mono-oleate poly(oxyethylene)ether, (monodecanoate sucrose), etc.

In the presence of surfactants of the invention, emulsion liquid is obtained through dispersion of wax for seed polymerization. The number average particle size of wax emulsion liquid is between 10-1000 nm, preferably in the range of 30-500 nm. In addition, the number average particle size is determined by LS230 (manufactured by Beckman Coulter Co.).

If the number average particle size of wax emulsion liquid is over 1000 nm, the number average particle size of polymer particles aggregated by seed polymerization would become too large. While forming toner particles, it is difficult to narrow the particle size distribution and obtain toner particles in small size. In addition, when the number average particle size of wax emulsion liquid is smaller than 10 nm, the amount of wax in the polymer particles obtained after seed polymerization is easy to diminish. Thus, it is possible to cause the lower effect of viscous roll resistance properties of low temperature fixing.

The method for wax dispersion is not limited, for example, the high-speed rotation devices such as clearmix (a disperser manufactured by M technique Co.) can be disperse through cut and cavitation. TK homogenizer (manufactured by PRIMIX Co.) can also be disperse through cut and cavitation. In addition, SC mill (a pulverizer manufactured by Mitsui Mining Co., Ltd.), as well as sand mill, can be used to disperse by use of medium.

In the presence of wax emulsion liquid, the methods for seed polymerization can be: radical polymerization monomers are added in turn into the wax emulsion liquid for radical polymerization while wax particles as a seed. Here, a polymerization initiator can be added to the wax emulsion liquid before or after radical polymerization monomer. In addition, radical polymerization monomer and initiator can be added together, and surfactants can also be added as a supplement.

The radical polymerization monomers of the invention could be styrene type, such as styrene, α-methyl styrene, chlorine styrene, dichlorostyrene, p-tert-butyl styrene, 4-butyl styrene and 4-nonyl styrene, or acrylate ester such as methyl acrylate, ethyl acrylate, propyl acrylate, n-butyl acrylate, iso-butyl acrylate, hydroxyethyl acrylate, ethylhexyl acrylate, methyl methacrylate, ethyl methacrylate, propyl methacrylate, n-butyl methacrylate, iso-butyl methacrylate, hydroxyethyl methacrylate, ethylhexyl methacrylate, etc. The preferred monomer is styrene and butyl acrylate.

Polarity-based radical polymerization monomer can also be used, in which acid-polarity based monomer could be carboxylic-based radical polymerization monomer, such as acrylic acid, methacrylic acid, maleic acid, fumaric acid, cinnamic acid, and sulfonic-based radical polymerization monomer, such as sulfonated styrene. Here, the preferred monomer is acrylic acid or methacrylic acid.

In addition, alkaline-polarity based radical polymerization monomer can be radical polymerization monomer containing nitrogen and heterocyclic ring, such as amino styrene and its quaternary salt, vinyl pyridine, vinylpyrrolidone, and amino-based crylic acid, such as dimethylamino ethyl acrylate, diethylamino ethyl methacrylate, as well as those quaternary amino acrylate esters containing ammonium salt (meta), acrylamide, N-propyl acrylamide, N,N-dimethyl acrylamide, N,N-dipropyl acrylamide, N,N-dibutyl acrylamide, acrylamide, etc.

These radical polymerization monomers can be used alone or mixed, but at this time, the glass transition temperature of polymer is preferably between 40 to 70° C. If the glass transition temperature is over 70° C., fixing temperature becomes too high, and there will sometimes occur problems of low fixation characteristics; on the other hand, when the glass transition temperature of polymer is below 40° C., the preservation stability of toner deteriorates, and aggregation problems occur sometimes.

The polymerization initiators could be water-soluble initiators of persulfate, such as kalium persulfate, sodium persulfate, ammonium persulfate, and redox polymerization initiators composed of these persulfates and reducing agents such as acid sodium sulfite or ascorbic acid. Moreover, the polymerization initiators could also be water-soluble initiators, such as hydrogen peroxide, 4,4′-Azobis(4-cyanovaleric acid), tert-butyl hydroperoxide, cumene hydroperoxide, and redox polymerization initiators composed of these water-soluble polymerization initiators and reducing agents such as ferrous salt or ascorbic acid. These polymerization initiators can be added to polymer system before, at the same time and at any time after radical polymerization monomer. The combination use of these adding methods can occur in accordance with the situation.

In order to adjust the molecular weight of polymer of this invention, chain transfer agent can be used in accordance with the situation. The specific examples of chain transfer agent are t-dodecyl mercaptan, n-dodecyl mercaptan, 2-mercapto ethanol, diisopropyl xanthogen, carbon tetrachloride, trichloromethyl bromide, etc. Individual chain transfer agent can be used alone, or two or more kinds mentioned above can be used together. Relative to radical polymerization, the largest use of radical polymerization monomer is preferably not more than 5% of weight. When the use is excessive, along with the decrease of molecular weight, the residue of radical polymerization monomer will become more, which is likely to cause the problem of a sharp smell.

If the amount of wax is 1-40 part by weight of every 100 party weight of the radical polymerization monomer, the preferred amount is 2-35 part, more preferably 5-30 part. When the amount of wax is too little, the release property is not good while fixing, and it is possible to cause stick adherence; in addition, if excessive, individual wax particles can be easily formed and wax will be attached to developers or carriers, so that it is possible to cause low durability.

The number average particle size of polymer particle A is preferably between 50-1500 nm, more preferably 70-700 nm. In addition, the number average particle size could be determined by LS230 (manufactured by Beckman Coulter Co.). When the number average particle size is smaller than 50 nm, the problem of so-called low release effect will occur due to little wax content. In addition, if the size is larger than 1500 nm, the control of toner particle size will be difficult. Sometimes, the particle size distribution will accordingly become wide.

In order to obtain the polymer particle B with inner colorant, it can be achieved by polymerization while colorant is used as a seed.

The colorants used for the polymerization as a seed can be inorganic pigments or organic pigments, organic dyes, but also can be the combinations. The specific examples are black colorants: carbon black, magnetite, black titanium, aniline black, black aniline dyes. Green colorants used can be pigment blue 15:3, pigment blue 15:4, etc. In addition, yellow colorants can be pigment yellow 14, pigment yellow 17, pigment yellow 93, pigment yellow 94, pigment yellow 138, pigment yellow 150, pigment yellow 155, pigment yellow 180, pigment yellow 185, solvent yellow 19, solvent yellow 44, solvent yellow 77, solvent yellow 162, etc. Magenta colorants can be Pigment Red 5, pigment red 48:1, pigment red 48:2, pigment red 48:3, pigment red 53:1, pigment red 57:1, pigment red 122, etc.

If the weight of bonding resin is 100, then the weight of these colorants is usually between 3-20.

These colorants are dispersed in aqueous medium for seed polymerization in the presence of surfactants, the same as the wax described above. The number average particle size of dispersive colorants is preferably between 50-1000 nm, more preferably 80-500 nm. The number average particle size can be determined by LS230 (manufactured by Beckman Coulter Co.).

If the number average particle size of dispersive colorants is bigger than 1000 nm, the average size of polymer particle obtained by seed polymerization will be too big. Thus it is difficult to make the particle size distribution narrow while forming toner, which is disadvantageous to obtain the toner with small particle size. In addition, when the number average particle size of dispersive colorants is smaller than 50 nm, the amount of colorant in the polymer particles obtained after seed polymerization is easy to diminish, associated with the possibility of keeping image concentration.

The method for wax dispersion is not limited, for example, the high-speed rotation devices such as clearmix, can be disperse through cut and cavitation. The TK homogenizer can also be disperse through cut and cavitation. In addition, SC mill, as well as sand mill, can be used to disperse by use of medium.

In the presence of colorant particle, the methods for seed polymerization can be: radical polymerization monomers are added in turn into the colorant dispersion for radical polymerization while colorant particles as a seed. Here, a polymerization initiator can be added to the wax emulsion liquid before or after polymerization monomer. In addition, monomer and initiator can be added together, and surfactants can also be added as a supplement.

With regard to surfactants, any kind of above-mentioned surfactants can be used.

In addition, the materials mentioned above can be used for radical polymerization monomers and polymerization initiators.

In addition, the chain transfer agents mentioned above can be used to regulate the molecular weight.

The number average particle size of polymer particle B is preferably between 50-1500 nm, more preferably 70-700 nm. In addition, the number average particle size is determined by LS230 (manufactured by Beckman Coulter Co.). When the number average particle size is smaller than 50 nm, due to inadequate gain of colorants content, it is possible to cause the release problem of colorants. In addition, when the size is larger than 1500 nm, the control of toner particle size will be difficult. Sometimes, the particle size distribution will accordingly become wide.

In addition, charge control agent can also be added in the toner of the invention. The charge control agent can be any well-known material, which can be used alone or together. The preferred positive charge is quaternary salts, and the preferred negative charge is salicylic acid or alkyl salicylic acid metal salt such as chromium, zinc, aluminum, metal complexes, methyl benzene acid metal salts, metal complexes of amino compounds, phenol compounds, naphthol compounds, aminophenol compounds, etc. The use of charge control agent is determined in accordance with the desired electric charge of toner. If the weight of bonding resin is 100, the weight of charge control agent is preferably between 0.01-10, more preferably 0.1-10.

The aggregation methods of polymer particle A with innerwax and polymer particle B with innercolorant are described as follows: add lectin salt for aggregation and then heat for fusion, or disperse polymer particle A and polymer particle B by surfactants with different polarity, and aggregate the mixture of polymer particle A and polymer particle B by heteroaggregation, then heat for fusion.

In order to make univalent or multivalent metal salt to be used as lectin salt, specifically, univalent metal salts can be sodium salt and potassium salt, such as sodium chloride, potassium chloride, etc; bivalent metal salts can be magnesium chloride, magnesium sulfate, calcium chloride, calcium sulfate, etc; trivalent metal salts can be aluminum hydroxide, aluminum chloride, etc.

With the aggregation of polymer particle A and polymer particle B and fusion by heating, add lectin salt below the glass transition temperature of polymer particles, and then heat as quickly as possible to be above the glass transition temperature of polymer particles. The preferred time of raising temperature is shorter than one hour. Moreover, the raise of temperature must be rapid, heating rate preferably to be more than 0.25° C./min. The ceiling is not particularly specific, but if the temperature raises instantaneously, the dramatically salting out will occur, which will cause the difficulty of controlling the particle size. Thus, the rate below 5° C./min is good. Through fusion, it is able to obtain the dispersion liquid polymer particle and any joint particle (colored particle) after salting out/fusion of any microparticle.

Finally, through filtration and washing, colorant particles are separated from aqueous medium. Here, the methods of filtration and washing could be centrifugal separation, or vacuum filtration by use of suction filter. Here, the methods of filtration and washing by use of pressure filter are not particularly limited.

Then dry the colored particle dry cake after washing, so as to obtain dry colored particle project. The dryer used in the project can be spray dryer, vacuum freeze dryer, vacuum dryer, in which the preferred dryer is static shelf dryer, mobile shelf dryer, fluid bed dryer, rotary dryer and stirring dryer. The water content of dry colored particles is preferably below 5% (mass ratio), more preferably below 2% (mass ratio). In addition, when the dry colored particles are aggregated by relatively weak gravitation between particles, the aggregated product can be broken. Here, the broken devices can be a jet mill, a Henshel mixer, a coffee mill, a food processing machine and other mechanical broken devices.

In addition, the mixture ratio of polymer particle A and polymer particle B is in accordance with the mass ratio of polymer particle A and polymer particle B, which is 1;0.5-1.2, and the preferred mass ratio is 1;0.6-1.0. While fixing, it is able to keep release property and tinting strength in the range. If the ratio of polymer particle A decreases, it is possible to cause the problem of release property while fixing. Moreover, if the ratio of polymer particle A increases, it is possible to cause low fluidity of toner due to the influence of wax, and the problem of low tinting strength due to the decreasing ratio of colorant.

To obtain polymer particles in the invention, charge control agent and wax can be used simultaneously as a seed, or charge control agent is dissolved or dispersed into monomer or wax, in which joint particle is preferably formed through simultaneous aggregation of polymer particle and charge control agent to obtain toner. Here, charge control agent in aqueous medium is preferably used as dispersion with the number average particle size 10-1000 nm. The charge control agent is added at the same time of aggregation project of polymer particle containing wax and polymer particle to cause aggregation.

While manufacturing the toner of the invention, the particle size of aggregated particle has virtually grown into the particle size of ultimate toner, then the same or different kinds of adhesive resins emulsion can be added to make the particles adhered to the surface so as to modify the toner properties in the surrounding surface.

In addition, additives used in the toner of the invention, such as liquid agents, are in accordance with the situation, in which the specific examples of liquid agents are hydrophobic silica, titanium dioxide, alumina and other micropowder. The amount of liquid agent is usually 0.01-5 part by weight of every 100 part of adhesive resins, preferably 0.1-3 part. The number average particle size of these liquid agents is preferably 5-80 nm.

In addition, inorganic micropowder used in the toner of the invention, such as magnetite, ferrite, cerium oxide, and strontium titanate, conductive titanium dioxide, or resistance regulator, slip agent such as styrene resin, acrylic resin can be used as internal additive or external additive. The amount of these additives is determined in accordance with the desired performance, preferably 0.05-10 part by weight of 100 parts of adhesive resins.

The relatively big particle size of additives is preferred, in which the number average particle size is 100-1000 nm.

The toner of static charge image of the invention can be used in the form of two-component developer or non-magnetic one-component developer. When it is used as a two-component developer, the carriers can be magnetic materials, such as iron powders, magnetite powders, ferrite powders etc., or other well-known materials that having resin coating on the surface of these materials, as well as magnetic carriers. The generally known cover resin of resin coating carriers can be styrene resin, acrylic resin, styrene-acrylic acid copolymer resin, silicone resin, modified silicone resin, fluorine resin, or compounds of these etc.

### BRIEF DESCRIPTION OF THE DRAWINGS

### Detailed Description of the Invention

Embodiment 1 for Preparing Resin Particle with Inner Wax

Dissolve 15 g behenyl behenate at 80° C. and add into 100 g sodium dodecyl benzene sulfonate aqueous solution with a concentration of 5% at 80° C. Disperse the solution with “clearmix” and determine the particle size by LS230 (manufactured by Beckman Coulter Co.), the number average particle size of which is 120 nm. Then, cool the dispersion liquid and add into the glass reactor containing stirring device, heating and cooling device, concentration device, as well as raw material inputs. Heat to 40° C. and add 800 g SDBS aqueous solution with a concentration of 5%. Afterwards, add 1.2 g potassium persulfate as water-soluble polymerization initiator, and heat to 85° C. for 1 hour. Subsequently, drop 100 g monomer solution, composed of 70 g styrene, 20 g butyl acrylate and 10 g methacrylic acid, for seed polymerization with the wax as a seed. The reaction is over after 7 hours, and then cool to 20° C. to determine the particle size. The particle size of resin with inner wax is 210 nm. The resin particle with inner wax is called polymer particle (A-1).

Embodiment 2 for Preparing Resin Particle with Inner Wax

In the embodiment 1 for preparing resin particle with inner wax, except that the amount of behenyl behenate is changed to 20 g, the resin particle with inner wax is obtained with no change of other conditions. The particle size of the resin particle with inner wax is 220 nm. The resin particle with inner wax is called polymer particle (A-2).

Embodiment 3 for Preparing Resin Particle with Inner Wax

In the embodiment 1 for preparing resin particle with inner wax, except that the amount of behenyl behenate is changed to 25 g, the resin particle with inner wax is obtained with no change of other conditions. The particle size of the resin particle with inner wax is 250 nm. The resin particle with inner wax is called polymer particle (A-3).

Embodiment 4 for Preparing Resin Particle with Inner Wax

In the embodiment 2 for preparing resin particle with inner wax, except that behenyl behenate is changed to carnuba wax (refining 1) and the dispersion temperature of wax is changed to 85° C., the resin particle with inner wax is obtained with no change of other conditions. The particle size of the resin particle with inner wax is 220 nm. The resin particle with inner wax is called polymer particle (A-4).

Embodiment 1 for Preparing Colorant with Inner Resin Particle

Add 16 g carbon black into 100 g SDBS aqueous solution with a concentration of 5%, disperse the solution with “clearmix” at 30° C., and determine the particle size by LS230 (manufactured by Beckman Coulter Co.), the number average particle size of which is 80 nm. Then, cool the dispersion liquid and add into the glass reactor containing stirring device, heating and cooling device, concentration device, as well as raw material inputs. Heat to 30° C. and add 800 g SDBS aqueous solution with a concentration of 5%. Afterwards, add 1.3 g potassium persulfate as water-soluble polymerization initiator, and heat to 85° C. for 1 hour. Subsequently, drop monomer solution, composed of 70 g styrene, 20 g butyl acrylate and 10 g methacrylic acid, for seed polymerization with the wax as a seed. The reaction is over after 7 hours, and then cool to 20° C. to determine the particle size. The particle size of the colorant with inner resin particle is 160 nm. The colorant with inner resin particle is called polymer particle (B-1).

Embodiment 2 for Preparing Colorant with Inner Resin Particle

In the embodiment 1 for preparing colorant with inner resin particle, except that the amount of carbon black is changed from 16 g to 20 g, the colorant with inner resin particle is obtained with no change of other conditions. The particle size of the colorant with inner resin particle is 180 nm. The colorant with inner resin particle is called polymer particle (B-2).

Embodiment 3 for Preparing Colorant with Inner Resin Particle

In the embodiment 1 for preparing colorant with inner resin particle, except that carbon black is changed to pigment red 122, the colorant with inner resin particle is obtained with no change of other conditions. The particle size of the colorant with inner resin particle is 210 nm. The colorant with inner resin particle is called polymer particle (B-3).

Embodiment 4 for Preparing Colorant with Inner Resin Particle

In the embodiment 1 for preparing colorant with inner resin particle, except that carbon black is changed to pigment yellow 74, the colorant with inner resin particle is obtained with no change of other conditions. The particle size of the colorant with inner resin particle is 205 nm. The colorant with inner resin particle is called polymer particle (B-4).

Embodiment 5 for Preparing Colorant with Inner Resin Particle

In the embodiment 1 for preparing colorant with inner resin particle, except that carbon black is changed to pigment blue 15:3, the colorant with inner resin particle is obtained with no change of other conditions. The particle size of the colorant with inner resin particle is 195 nm. The colorant with inner resin particle is called polymer particle (B-5).

Embodiment 1 for Preparing Toner

Mix the dispersion liquid containing above-mentioned polymer particle (A-1) and polymer particle (B-1), stirring at 30° C. while dropping 300 g magnesium chloride solution (20% concentration) in 30 minutes, then heat to 80° C. and monitor the growth of particle size. When the particle size (median size of volume base: using Kurt Multi sizer II manufactured by Beckman Coulter to determine) reaches 6.5 μm, add 300 g water to stop the particle size growth. Then heat to 95° C. for 5 hours to form spherical shape, and cool to 20° C. when the shape factor reaches 0.965 (determined by FPIA-3000). Then, use centrifugal separator to filter, water to wash, and heat for vacuum dry. Add 2 g hydrophobic silicon dioxide (treated with Hexamethyldisilazane, the number average particle size=12 nm) and 1 g hydrophobic titanium dioxide (treated with Octyltrimethyl silane, the number average particle size=25 nm) to 200 g dried particles, use a Henshel mixer to mix, and the obtained toner is called toner 1.

Embodiment 2 for Preparing Toner

In the embodiment 1 for preparing toner, except that polymer particle (B-1) is changed to polymer particle (B-2), the toner is obtained with no change of other conditions. The obtained toner is called toner 2.

Embodiment 3 for Preparing Toner

In the embodiment 1 for preparing toner, except that polymer particle (A-1) is changed to polymer particle (A-2), the toner is obtained with no change of other conditions. The obtained toner is called toner 3.

Embodiment 4 for Preparing Toner

In the embodiment 1 for preparing toner, except that polymer particle (A-1) is changed to polymer particle (A-3), the toner is obtained with no change of other conditions. The obtained toner is called toner 4.

Embodiment 5 for Preparing Toner

In the embodiment 1 for preparing toner, except that polymer particle (A-1) is changed to polymer particle (A-4), the toner is obtained with no change of other conditions. The obtained toner is called toner 5.

Embodiment 6 for Preparing Toner

In the embodiment 1 for preparing toner, except that polymer particle (B-1) is changed to polymer particle (B-3), the toner is obtained with no change of other conditions. The obtained toner is called toner 6.

Embodiment 7 for Preparing Toner

In the embodiment 1 for preparing toner, except that polymer particle (B-1) is changed to polymer particle (B-4), the toner is obtained with no change of other conditions. The obtained toner is called toner 7.

Embodiment 8 for Preparing Toner

In the embodiment 1 for preparing toner, except that polymer particle (B-1) is changed to polymer particle (B-5), the toner is obtained with no change of other conditions. The obtained toner is called toner 8.

Embodiment 9 for Preparing Toner

In the embodiment 3 for preparing toner, except that polymer particle (B-1) is changed to polymer particle (B-3), the toner is obtained with no change of other conditions. The obtained toner is called toner 9.

Embodiment 10 for Preparing Toner

In the embodiment 3 for preparing toner, except that polymer particle (B-1) is changed to polymer particle (B-4), the toner is obtained with no change of other conditions. The obtained toner is called toner 10.

Embodiment 11 for Preparing Toner

In the embodiment 3 for preparing toner, except that polymer particle (B-1) is changed to polymer particle (B-5), the toner is obtained with no change of other conditions. The obtained toner is called toner 11.

Embodiment 12 for Preparing Toner

In the embodiment 9 for preparing toner, except that polymer particle (A-2) is changed to polymer particle (A-4), the toner is obtained with no change of other conditions. The obtained toner is called toner 12.

Embodiment 13 for Preparing Toner

In the embodiment 10 for preparing toner, except that polymer particle (A-2) is changed to polymer particle (A-4), the toner is obtained with no change of other conditions. The obtained toner is called toner 13.

Embodiment 14 for Preparing Toner

In the embodiment II for preparing toner, except that polymer particle (A-2) is changed to polymer particle (A-4), the toner is obtained with no change of other conditions. The obtained toner is called toner 14.

Comparative Toner 1

In embodiment 1 for preparing toner, expect that polymer particle (B-1) is changed to 8 g carbon black added into 50 g SDBS aqueous solution with a concentration of 5%, and the dispersion liquid (BK-1) with the number average particle size of 80 nm is formed by dispersion with “clearmix” at 30° C., the comparative toner 1 is obtained with no change of other conditions.

Comparative Toner 2

In embodiment 1 for preparing toner, expect that carbon black is changed to pigment yellow 74, the comparative toner 2 is obtained with no change of other conditions.

Comparative Toner 3

In embodiment 1 for preparing toner, expect that carbon black is changed to pigment red 122, the comparative toner 3 is obtained with no change of other conditions.

Comparative Toner 4

In embodiment 1 for preparing toner, expect that carbon black is changed to pigment blue 15:3, the comparative toner 4 is obtained with no change of other conditions.

Comparative Toner 5

In embodiment 1 for preparing toner, expect that polymer particle (A-1) is changed to 50 g SDBS aqueous solution with a concentration of 5% at 80° C., in which 8 g behenyl behenate dissolved at 80° C. is added to the solution, and the dispersion liquid (wax 1) with the number average particle size of 120 nm is formed by dispersion with “clearmix”, the comparative toner 5 is obtained with no change of other conditions.

Comparative Toner 6

In embodiment 6 for preparing toner, expect that polymer particle (A-1) is changed to 50 g SDBS aqueous solution with a concentration of 5% at 80° C., in which 8 g behenyl behenate dissolved at 80° C. is added to the solution, and the dispersion liquid (wax 1) with the number average particle size of 120 nm is formed by dispersion with “clearmix”, the comparative toner 6 is obtained with no change of other conditions.

Comparative Toner 7

In embodiment 7 for preparing toner, expect that polymer particle (A-1) is changed to 50 g SDBS aqueous solution with a concentration of 5% at 80° C., in which 8 g behenyl behenate dissolved at 80° C. is added to the solution, and the dispersion liquid (wax 1) with the number average particle size of 120 nm is formed by dispersion with “clearmix”, the comparative toner 7 is obtained with no change of other conditions.

Comparative Toner 8

In embodiment 8 for preparing toner, expect that polymer particle (A-1) is changed to 50 g SDBS aqueous solution with a concentration of 5% at 80° C., in which 8 g behenyl behenate dissolved at 80° C. is added to the solution, and the dispersion liquid (wax 1) with the number average particle size of 120 nm is formed by dispersion with “clearmix”, the comparative toner 8 is obtained with no change of other conditions.

Evaluation

The above-mentioned toners are used to evaluate the fixation (roll viscosity) and durability.

Use the non-magnetic one-component printer to evaluate these toners. The printer used is ColorLaserJet 2605 manufactured by HP Co.

Roll Viscosity

The printer is used under low temperature and low humidity (10° C./10% RH) to continuously print 1000 sheets of stipple pattern (full pixel rate 40% halftone image), in which the pixel rate of yellow/magenta/green/black is 10%. Then, maintain the OFF state of power for 1 night. In the morning of the following day, monitor the fixing part with eyes to observe whether the toner is spitted out.

Durability

The printer is used under high temperature and high humidity (33° C./85% RH) for printing characters and images with 1% pixel rate of yellow/magenta/green/black, and 4000 sheets of characters are continuously printed in 1 piece intermittent mode (10 seconds rest after every 1 sheet). Then, compare the imaging density (black) of the initial imaging and the 4,000^{th} imaging, and the fog density through image reflection density with paper reflection density ┌0┘. After that, the comparison of color gamut formed by Y/M/C and B/G/R is achieved under visual observation. Compare the color gamut formed after the 4,000^{th} imaging while the area of initial color gamut is set as 100.

The following combinations of toners are used:

Embodiment 1: toner 1/toner 6/toner 7/toner 8

Embodiment 2: toner 2/toner 6/toner 7/toner 8

Embodiment 3: toner 3/toner 6/toner 7/toner 8

Embodiment 4: toner 4/toner 6/toner 7/toner 8

Embodiment 5: toner 5/toner 6/toner 7/toner 8

Embodiment 6: toner 2/toner 9/toner 10/toner 11

Embodiment 7: toner 2/toner 12/toner 13/toner 14

Comparative embodiment 1: comparative toner 1/comparative toner 2/comparative toner 3/comparative toner 4

Comparative embodiment 2: comparative toner 5/comparative toner 6/comparative toner 7/comparative toner 8

Evaluation Results

| | Whether spitting out after 1000th imaging |
|---|---|
| Embodiment 1 | no |
| Embodiment 2 | no |
| Embodiment 3 | no |
| Embodiment 4 | no |
| Embodiment 5 | no |
| Embodiment 6 | no |
| Embodiment 7 | no |
| Comparative embodiment 1 | relatively slight |
| Comparative embodiment 2 | obvious |

Evaluation Result

| | Initial stage | | | After 4000th imaging | | |
|---|---|---|---|---|---|---|
| | Imaging | | | Imaging | | |
| | density | Fog | Color | density | Fog | Color |
| | (black) | density | gamut | (black) | density | gamut |
| Embodiment 1 | 1.39 | 0.000 | 100 | 1.39 | 0.001 | 99 |
| Embodiment 2 | 1.38 | 0.000 | 100 | 1.39 | 0.001 | 99 |
| Embodiment 3 | 1.39 | 0.000 | 100 | 1.39 | 0.002 | 99 |
| Embodiment 4 | 1.39 | 0.000 | 100 | 1.39 | 0.001 | 99 |
| Embodiment 5 | 1.39 | 0.000 | 100 | 1.39 | 0.001 | 99 |
| Embodiment 6 | 1.39 | 0.000 | 100 | 1.38 | 0.001 | 99 |
| Embodiment 7 | 1.39 | 0.000 | 100 | 1.39 | 0.001 | 98 |
| Comparative | 1.38 | 0.000 | 100 | 1.26 | 0.006 | 87 |
| embodiment 1 | | | | | | |
| Comparative | 1.39 | 0.000 | 100 | 1.25 | 0.012 | 85 |
| embodiment 2 | | | | | | |

Thus, the toner of the invention could maintain long-term stable performance.

What is claimed is:

1. A toner of static charge image, characterized in that, for the toner of static charge image obtained by aggregation of at least polymer particles, the polymer particles at least contain polymer particles A with inner wax and polymer particles B with inner colorant.

2. The toner of static charge image according to claim 1, characterized in that polymer particles A are obtained by seed polymerization with wax particle as the seed particle.

3. The toner of static charge image according to claim 1, characterized in that polymer particles B are obtained by seed polymerization with colorant as the seed particle.

4. A method for manufacturing the toner of static charge image, characterized in that, polymer particle A dispersion liquid, obtained by adding radical polymerization monomer for seed polymerization in the presence of wax particle, is mixed with polymer particle B dispersion liquid, obtained by adding radical polymerization monomer for seed polymerization in the presence of colorant particle, to form the joint particle by particle aggregation.

5. The method for manufacturing the toner of static charge image according to claim 4, characterized in that the mixture ratio of polymer particle A and polymer particle B is in accordance with the mass ratio of polymer particle A and polymer particle B=1;0.5-1.2.

6. The method for manufacturing the toner of static charge image according to claim 5, characterized in that the mixture ratio of polymer particle A and polymer particle B is in accordance with the mass ratio of polymer particle A and polymer particle B=1;0.6-1.0.
